(19) United States
(12) Patent Application Publication
(10) Pub. No.: US 2024/0121126 A1
(43) Pub. Date: Apr. 11, 2024

(54) DIGITAL BRIDGING OVER ADVANCED PHYSICAL LAYER

(71) Applicant: Schneider Electric Systems USA, Inc., Foxborough, MA (US)

(72) Inventors: Briane Ritchie, Bellingham, MA (US); Richard Allan Chaney, Canterbury, NH (US); Mark V. Bertolina, Milton, MA (US); Alexander Johnson, Houston, TX (US); Jeffrey Mattar, Foxborough, MA (US); Matthew Briggs Michel, Upton, MA (US); Ashutosh Diliprao Katke, Pune (IN)

(73) Assignee: Schneider Electric Systems USA, Inc., Foxborough, MA (US)

(21) Appl. No.: 18/484,002

(22) Filed: Oct. 10, 2023

Related U.S. Application Data
(60) Provisional application No. 63/414,607, filed on Oct. 10, 2022.
(60) Provisional application No. 63/414,845, filed on Oct. 10, 2022.

(51) Int. Cl. H04L 12/28; H04L 12/66

(52) U.S. Cl. CPC H04L 12/2801; H04L 12/66

(57) ABSTRACT

Digital bridging of field devices to an industrial network using an Ethernet Advanced Physical Layer (Ethernet-APL) bridge device. The APL bridge device includes analog interfaces for current-driven and voltage-driven measurement devices and an Intrinsically Safe (IS) APL connection providing power to the bridge device and the measurement devices. The bridge device enables gateway functionality between field device protocols and industrial network protocols.

### CROSS-REFERENCE TO RELATED APPLICATIONS

This application claims priority to U.S. Provisional Patent Application No. 63/414,607, filed Oct. 10, 2022, and U.S. Provisional Patent Application No. 63/414,845, filed Oct. 10, 2022, the entire disclosures of which are incorporated herein by reference.

### FIELD

The present disclosure relates generally to industrial networks, and more particularly, to systems and methods relating to bridging intrinsically safe analog measurements to industrial networks for Process Control and Automation.

### BACKGROUND

As is known, an industrial operation or plant typically includes industrial equipment often in a variety of forms and associated with various processes, for example, depending on the industrial operation. For example, an industrial operation may include one or more field devices (e.g., remote terminal units (RTUs), programmable logic controllers (PLCs), actuators, sensors, human-machine interfaces (HMIs)) that are used perform, analyze and/or control process variable measurements. These process variable measurements may include pressure, flow, level, and temperature, for example. The industrial operation or plant, and its associated equipment and process(es), are in some instances operated and controlled using a Distributed Control System (DCS).

Hazardous locations within an industrial plant require strict protection methods to eliminate possible electrical ignition sources. Conventional methods and systems for intrinsic safety have generally been considered satisfactory for their intended purpose but there is still a need in the art for improvements, including a device to provide this protection while also providing digital input/output.

### SUMMARY

Aspects of the present disclosure permit bridging intrinsically safe (IS) analog measurements to industrial networks for Process Control and Automation and provide an intrinsically safe endpoint field device having an Ethernet Advanced Physical Layer (Ethernet-APL) interface for digital input/output. In accordance with one or more embodiments of this disclosure, a system can include one or more endpoint field devices that are APL based, intrinsically safe, and that have galvanically isolated digital inputs and outputs. Such a system can provide the capability to monitor and to control external digital circuits through internet protocol (IP) via a 10BaseT1L APL interface. Hazardous locations can require strict protection methods to eliminate any possible electrical ignition source and embodiments of the present disclosure can provide this protection while also providing the APL interface.

In an aspect, an IS endpoint field device includes a 10BaseT1L APL IP interface. One or more galvanically isolated digital inputs/outputs are coupled to the 10BaseT1L APL IP interface and configured for coupling one or more external digital circuits to the IS endpoint field device via the APL IP interface. The IS endpoint field device is configured for monitoring and controlling the one or more external digital circuits through IP via the APL IP interface.

In another aspect, a method of digital bridging of one or more field devices to an industrial network includes providing a 10BaseT1L APL IP interface and coupling one or more galvanically isolated digital inputs/outputs the APL IP interface. The method also includes coupling one or more external digital circuits to the APL IP interface and monitoring and controlling the one or more external digital circuits through IP via the APL IP interface.

Other objects and features of the present invention will be in part apparent and in part pointed out herein.

### BRIEF DESCRIPTION OF THE DRAWINGS

FIG. 1 illustrates an example industrial operation in accordance with embodiments of the disclosure.

FIG. 2 illustrates an example APL bridge device having dual APL ports in accordance with embodiments of the disclosure.

FIG. 3 illustrates another example APL bridge device with dual APL ports in accordance with embodiments of the disclosure.

FIG. 4 shows an example implementation of digital input/output in accordance with embodiments of the disclosure.

FIG. 5 illustrates an example Data Manager architecture for use with the disclosed digital input/output in accordance with embodiments of the disclosure.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

As described above, hazardous locations require strict protection methods to eliminate possible electrical ignition sources that could result in fire, explosions, or the like. Aspects of the present disclosure provide an intrinsically safe endpoint field device that delivers this protection while also providing an interface compatible with APL, which is a specific single-pair Ethernet (SPE) based on 10BASE-T1L, for digital input/output.

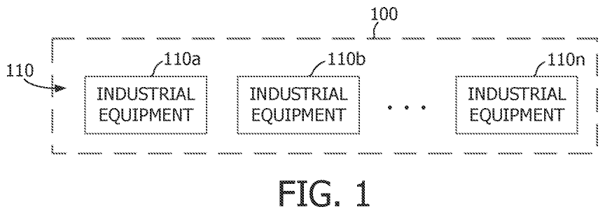

Referring to FIG. 1, an example industrial operation 100 in accordance with embodiments of the disclosure includes a plurality of industrial devices, or equipment, 110a, 110b, . . . , 110n (indicated collectively as industrial equipment 110). The industrial equipment (or devices) 110 may be associated with a particular application (e.g., an industrial application), applications, and/or process(es). The industrial equipment 110 may include electrical or electronic equipment, for example, such as machinery associated with the industrial operation 100 (e.g., a manufacturing or natural resource extraction operation). The industrial equipment 110 may also include the controls and/or ancillary equipment associated with the industrial operation 100, for example, field devices (e.g., RTUs, PLCs, actuators, sensors, HMIs) that are used perform, analyze and/or control process variable measurements. In embodiments, the industrial equipment 110 may be installed or located in one or more facilities (i.e., buildings) or other physical locations (i.e., sites) associated with the industrial operation 100. The facilities may correspond, for example, to industrial buildings or plants. Additionally, the physical locations may correspond, for example, to geographical areas or locations.

The industrial equipment 110 may each be configured to perform one or more tasks in some embodiments. For example, at least one of the industrial equipment 110 may be configured to produce or process one or more products, or a portion of a product, associated with the industrial operation 100. Additionally, at least one of the industrial equipment 110 may be configured to sense or monitor one or more parameters (e.g., industrial parameters) associated with the industrial operation 100. For example, industrial equipment 110a may include or be coupled to a temperature sensor configured to sense temperature(s) associated with the industrial equipment 110a, for example, ambient temperature proximate to the industrial equipment 110a, temperature of a process associated with the industrial equipment 110a, temperature of a product produced by the industrial equipment 110a, etc. The industrial equipment 110a may additionally or alternatively include one or more pressure sensors, flow sensors, level sensors, vibration sensors and/or any number of other sensors, for example, associated the application(s) or process(es) associated with the industrial equipment 110a. The application(s) or process(es) may involve water, air, gas, electricity, steam, oil, etc. in one example embodiment.

The industrial equipment 110 may take various forms and may each have an associated complexity (or set of functional capabilities and/or features). For example, industrial equipment 110a may correspond to a “basic” industrial equipment, industrial equipment 110b may correspond to an “intermediate” industrial equipment, and industrial equipment 110n may correspond to an “advanced” industrial equipment. In such embodiments, intermediate industrial equipment 110b may have more functionality (e.g., measurement features and/or capabilities) than basic industrial equipment 110a, and advanced industrial equipment 110n may have more functionality and/or features than intermediate industrial equipment 110b. For example, in embodiments industrial equipment 110a (e.g., industrial equipment with basic capabilities and/or features) may be capable of monitoring one or more first characteristics of an industrial process, and industrial equipment 110n (e.g., industrial equipment with advanced capabilities) may be capable of monitoring one or more second characteristics of the industrial process, with the second characteristics including the first characteristics and one or more additional parameters. It is understood that this example is for illustrative purposes only, and likewise in some embodiments the industrial equipment 110a, 110b, 110n, etc. may each have independent functionality.

As described above, the industrial operation 100, and its associated equipment and process(es), may be operated and controlled using a DCS in some instances.

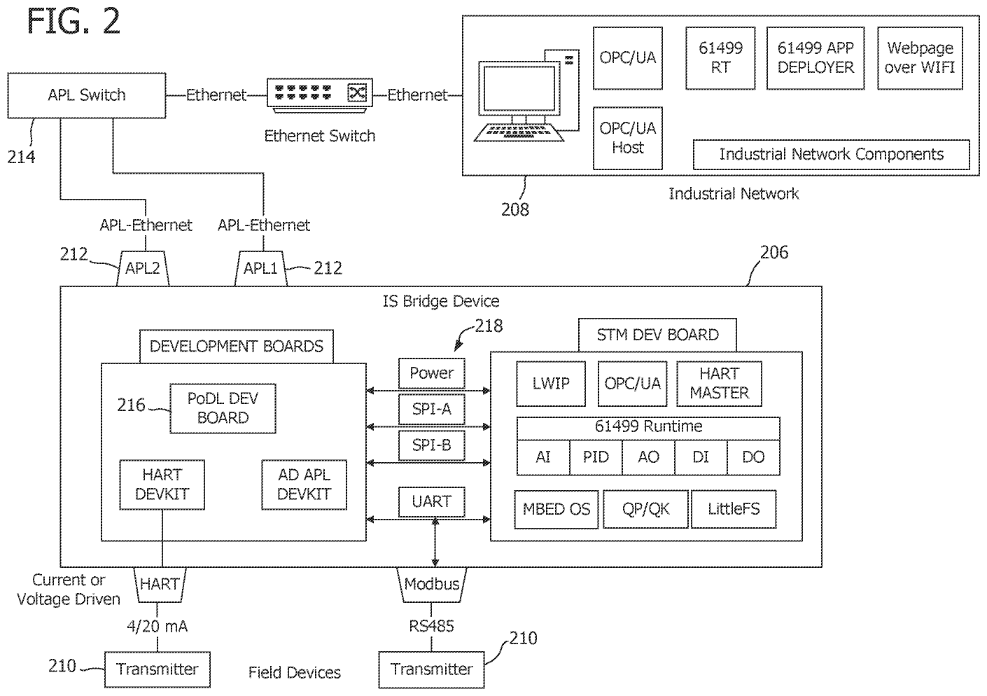

FIG. 2 shows an example Ethernet-APL bridge 206 in accordance with embodiments of the present disclosure. The APL bridge 206 provides communication between an industrial network 208, such as the DCS mentioned above, and industrial equipment 110 (i.e., an edge field device 210 in the illustrated embodiment). The APL bridge 206 includes two or more physical APL 10BaseT1 ports 212. Each port 212 connects the field devices 210 to the industrial network 208 via an APL switch 214. As described below, the dual ports 212 of APL bridge 206 enables network traffic separation and high availability implementations. In addition, APL bridge 206 includes on-board Power over Data Lines (PoDL) components indicated at 216 and power supply, network port, cable, and on-board network interface components indicated at 218. In this manner, the APL bridge 206 of the illustrated embodiment allows an IS Field Device, i.e., field device 210, to connect over Ethernet-APL to an industrial Ethernet network 208 while maintaining intrinsic safety all the way to the APL switch 214.

In an embodiment, each APL port 212 connects to its corresponding APL switch 214 via 2-wire intrinsically safe Ethernet (2-WISE) 10BASE-T1L. Redundant APL ports 212 and the network interface components may be targeted for use in both ordinary and hazardous locations. The APL switch 214 in FIG. 2 combines communication technology with Ethernet-APL and permits transmitting power and data on an Ethernet wire into hazardous areas of a process plant. In a hazardous environment, power to field devices 210 is limited to an intrinsically safe threshold to reduce the risk of fire, explosions, or the like. The system of FIG. 2 includes a power limited source operatively connected to field devices 210 and configured to supply a main power to field devices 210 up to a power limit threshold. In this instance, the power limited source comprises APL bridge 206, which can be intrinsically safe. As shown in FIG. 2, field devices 210 comprise Intrinsically Safe Edge Field Devices with redundant APL port and network interface components in accordance with embodiments of the present disclosure.

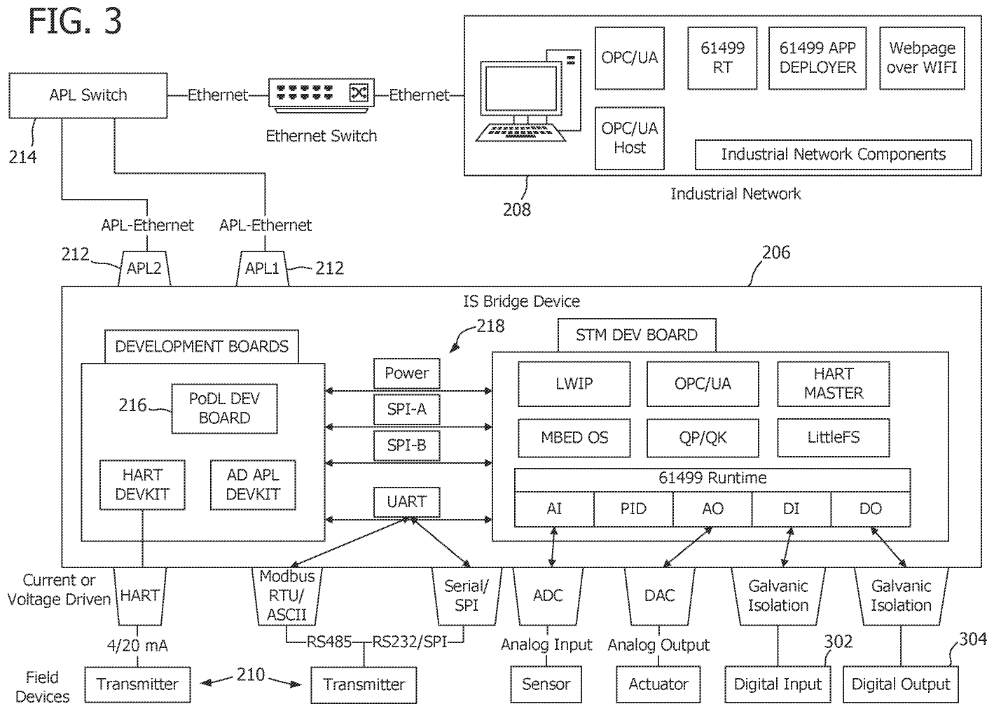

Referring now to FIG. 3, another example implementation of APL bridge 206 having dual APL ports 212 is shown in accordance with embodiments of the disclosure. In the embodiment of FIG. 3, APL bridge 206 provides APL-powered intrinsically safe galvanically isolated digital inputs, such as digital input 302, and intrinsically safe galvanically isolated digital outputs, such as digital output 304. Advantageously, a networked IS device can connect to the galvanically isolated digital input/output 302,304 to read the digital input 302 and to control the digital output 304 even in a hazardous location via APL bridge 206. In an aspect, APL bridge 206 as shown in FIG. 3, for example, provides connectivity over Ethernet-APL. Additionally, APL bridge 206 supports both current-driven and voltage-driven analog measurements as well as supports HART (Highway Addressable Remote Transducer) and Modbus RTU/ASCII protocols, RS-485, RS-232, and SPI serial connections on the measurement interface. The APL bridge 206 also provides Ethernet-based industrial protocols (e.g., OPC-FX, OPC-UA, Ethernet IP, Modbus TCP, HART-IP, PROFINET, CANopen, DeviceNet, Foundation Fieldbus, EtherCAT) on the side of industrial network 208. The APL bridge 206 allows an intrinsically safe field device 210 to connect over Ethernet-APL to an industrial Ethernet network 208 while maintaining intrinsic safety all the way to APL switch 214. For example, APL powered, intrinsically safe current-driven loop (4/20 mA) HART signaling bridges to digital over APL via APL bridge 206, which allows a networked IS device to connect to an IS current-driven field device in Layer 0. Similarly, APL powered, intrinsically safe voltage-driven loop (0-5 V) HART signaling bridges to digital over APL via APL bridge 206, which allows a networked IS device to connect to an IS voltage-driven field device in Layer 0.

In one aspect of the present disclosure, the APL bridge 206 is an APL Ethernet Bridge Device with Dual APL ports 212, such as shown in FIG. 3, to enable network traffic separation and high availability implementations. The dual APL ports 212 allow for physical separation of different classifications of traffic from industrial network 208 to the Edge devices, such as field devices 210, connected through the APL bridge 206. The dual APL ports 212 also allow for increased power to the APL bridge 206 and Edge devices connected beyond. In one example implementation, an end user/installer has the option to use traditional wire spade lugs, terminal strip and cable glands, or circular connectors. These options may be shipped with each bridge 206, for example. Using two (or more) APL port 212 connectors for IS Edge devices with the option to use traditional wire spade lugs, terminal strip and cable glands, or circular connectors enables simultaneous, independent Control and OAM (web server-based) interfaces supported over separate APL connections for Edge components. Additionally, it allows for increased power to APL bridge 206 and Edge devices connected behind the bridge 206. One or both of the dual ports 212 of Ethernet-APL bridge 206 can be active, connected or single wire pair only.

As will be appreciated further from a review of FIG. 2 and FIG. 3, for example, in one aspect the disclosed APL bridge 206 provides analog interfaces for current and voltage-driven measurement devices (see field devices 210) with all power to APL bridge 206 and field devices 210 being provided via the IS APL connection. Software executed by circuitry of APL bridge 206 provides gateway functionality between the field device protocols (e.g., HART or Modbus RTU) and the industrial network protocols, including acting as an OPC-UA/FX server with publish/subscribe support for OPC-UA/FX clients. For example, HART over APL implemented on field device 210 supports conversion between the HART protocol and a desired network digital protocol, such as OPC-FX in Client/Server and Pub/Sub modes. Similarly, Modbus over APL implemented on field device 210 supports conversion between the Modbus RTU protocol and a desired network digital protocol, such as OPC-FX in Client/Server and Pub/Sub modes.

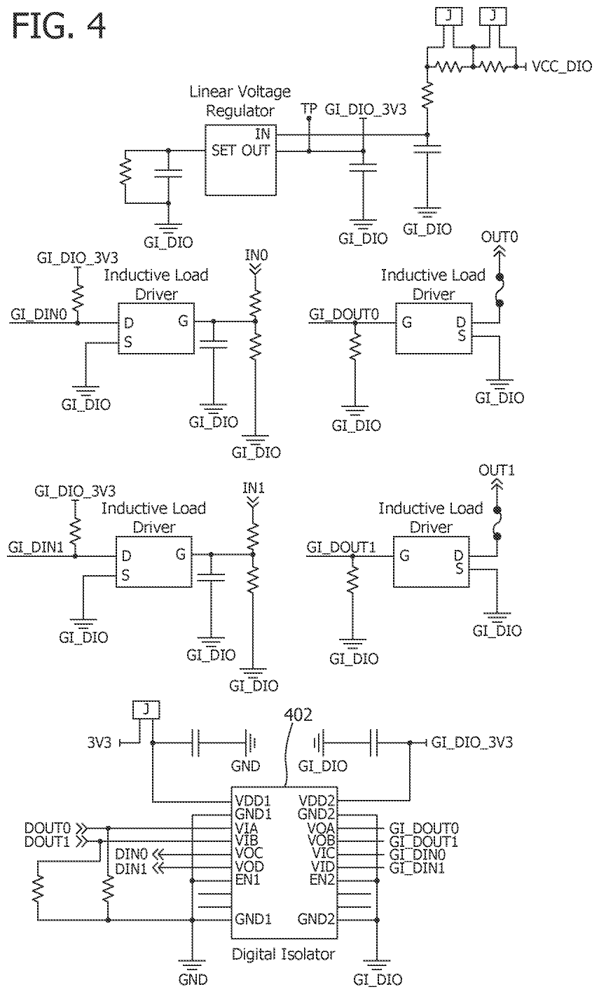

As described above, aspects of the present disclosure galvanic isolation between the power limited source and field devices 210. FIG. 4 shows an example implementation of digital input/output in which a digital isolator chip 402 isolates both sides and provide a digital I/O off of an APL system with galvanic isolation. In an embodiment, an ADUM1442ARSZ digital isolator available from Analog Devices embodies a suitable chip 402. An APL-based, intrinsically safe endpoint field device 210 employing galvanically isolated digital inputs and outputs, such as disclosed in FIG. 4, provides the capability to monitor and to control external digital circuits through IP via its 10BaseT1L APL interface.

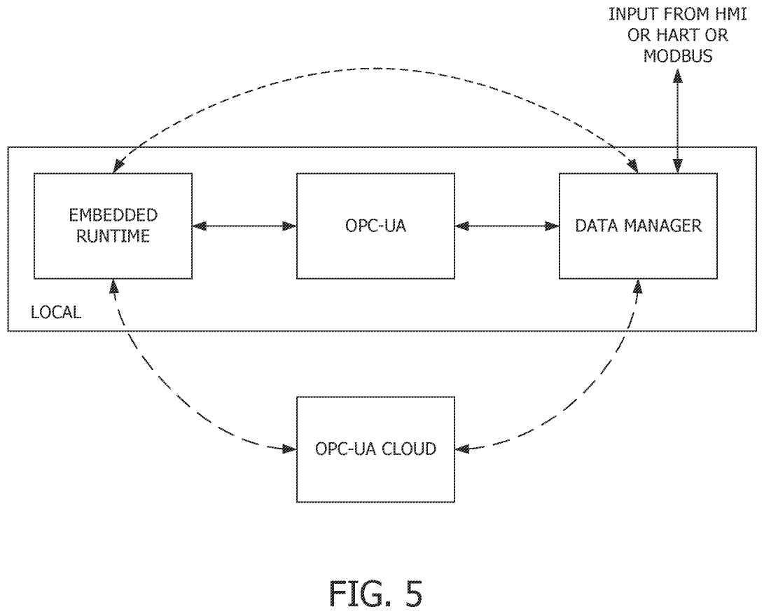

Digital bridging over APL further enables a Data Manager with Server for sharing data between the Edge and the network. FIG. 5 illustrates an example Data Manager architecture that may be suitable for use with aspects of the present disclosure. In one example implementation, the data from an HMI, HART (Highway Addressable Remote Transducer) device, Modbus device, etc. can be gathered and the interface can be used to provide the data internally or externally via the hosting server (Data Manager). This provides the flexibility to the access the data internally or externally via same medium. In accordance with embodiments of the present disclosure, there will be no extra work required if an external device requires the data to be read from the local device.

In an embodiment, an APL bridge device includes analog interfaces for current-driven and voltage-driven measurement devices with all power to the APL bridge device and the measurement devices being provided via an IS APL connection. The APL bridge device software provides gateway functionality between field device protocols (e.g., HART or Modbus RTU) and industrial network protocols, including acting as an OPC-UA/FX server with publish/subscribe support for OPC-UA/FX clients.

In an embodiment, an APL bridge device includes one or more analog interfaces for at least one of a current-driven and a voltage-driven measurement device and an IS APL connection providing power to the bridge device and the measurement device. The bridge device also includes a processor and a memory storing processor-executable instructions that, when executed, configure the processor to enable gateway functionality between one or more field device protocols and one or more industrial network protocols. The field device protocols include one or more of HART and Modbus RTU and the industrial network protocols are configured to operate the APL bridge device as an OPC-UA/FX server with publish/subscribe support for OPC-UA/FX clients. The APL bridge device also includes a 10BaseT1L APL IP interface, galvanically isolated digital inputs coupled to the interface and configured for coupling external digital circuits to the APL bridge device via the interface and galvanically isolated digital outputs coupled to the interface and configured for coupling the external digital circuits to the APL bridge device via the interface. In this manner, the APL bridge device permits monitoring and controlling the external digital circuits through IP via the interface.

For convenience, certain introductory concepts and terms used in the specification are collected here.

As used herein, the term “Edge” is used to refer to Layer 0 of the Purdue Network Model for Industrial Control Systems.

As used herein, the term “Field Device” is used to refer to Equipment that is connected to the field side on an industrial control system. Types of field devices include RTUs, PLCs, actuators, sensors, HMIs, and associated communications as well as intelligent field instruments with embedded Control/Compute/measurement capability implemented on lower power embedded Microcontroller based platforms.

As used herein, the term “Machine Learning (ML)” is used to refer to the use and development of software that is able to learn and adapt without following explicit instructions, by using algorithms and statistical models to analyze and draw inferences from patterns in data.

As used herein, the term “Embedded Device” is used to refer to a combination of a microcontroller, memory, and input/output peripherals—that has a dedicated function within a larger system.

As used herein, the term “Networked” is used to refer to connected via Ethernet.

As used herein, the term “High availability” is used to refer to a device or application that can operate at a high level, continuously, without intervention, for a given time period. High-availability infrastructure is configured to deliver quality performance and handle different loads and failures with minimal or zero downtime.

As used herein, the term “Intrinsically Safe (IS)” is used to refer to an approach to the design of equipment going into hazardous areas that reduces the available energy to a level where it is too low to cause ignition as certified by per IEC TS 60079-39 or ATEX.

It is understood that aspects of the present disclosure may be found suitable for use in numerous applications, including but not limited to Oil and Gas, Energy, Food and Beverage, Water and Wastewater, Chemical, Petrochemical, Pharmaceutical, Metal, and Mining and Mineral applications.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments may be implemented with processor-executable instructions. The processor-executable instructions may be organized into one or more processor-executable components or modules on a tangible processor readable storage medium. Also, embodiments may be implemented with any number and organization of such components or modules. For example, aspects of the present disclosure are not limited to the specific processor-executable instructions or the specific components or modules illustrated in the figures and described herein. Other embodiments may include different processor-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. An intrinsically safe (IS) endpoint field device, comprising:
a 10BaseT1L Advanced Physical Layer (APL) Internet Protocol (IP) interface;
one or more galvanically isolated digital inputs coupled to the 10BaseT1L APL IP interface and configured for coupling one or more external digital circuits to the IS endpoint field device via the 10BaseT1L APL IP interface; and
one or more galvanically isolated digital outputs coupled to the 10BaseT1L APL IP interface and configured for coupling the one or more external digital circuits to the IS endpoint field device via the 10BaseT1L APL IP interface,
wherein the IS endpoint field device is configured for monitoring and controlling the one or more external digital circuits through IP via the 10BaseT1L APL IP interface.

2. The IS endpoint field device of claim 1, further comprising a plurality of redundant physical Ethernet-APL 10BaseT1L ports connecting the IS endpoint field device to an industrial network via at least one Ethernet-APL switch, the redundant ports configured to enable network traffic separation and high availability.

3. The IS endpoint field device of claim 2, wherein the redundant ports are configured to enable network traffic separation based on different classifications of traffic from the industrial network to the IS endpoint field device.

4. The IS endpoint field device of claim 1, wherein the 10BaseT1L APL IP interface is configured to connect to an industrial network via at least one Ethernet-APL switch and to receive Power over Data Lines (PoDL) from the at least one Ethernet-APL switch.

5. The IS endpoint field device of claim 4, wherein the 10BaseT1L APL IP interface connects to the at least one Ethernet-APL switch via two-wire intrinsically safe Ethernet (2-WISE) 10BaseT1L.

6. The IS endpoint field device of claim 1, further comprising:
one or more analog interfaces for at least one of a current-driven and a voltage-driven measurement device; and
an intrinsically safe (IS) APL connection providing power to the IS endpoint field device and the measurement device.

7. The IS endpoint field device of claim 6, further comprising:
a processor; and
a memory storing processor-executable instructions that, when executed, configure the processor to enable gateway functionality between one or more field device protocols and one or more industrial network protocols.

8. The IS endpoint field device of claim 7, wherein the field device protocols include one or more of HART and Modbus RTU.

9. The IS endpoint field device of claim 7, wherein the industrial network protocols are configured to operate the IS endpoint field device as an OPC-UA/FX server with publish/subscribe support for OPC-UA/FX clients.

10. The IS endpoint field device of claim 1, wherein one or more edge devices are connected to the 10BaseT1L APL IP interface.

11. A method of digital bridging of one or more field devices to an industrial network, the method comprising:
providing a 10BaseT1L Advanced Physical Layer (APL) Internet Protocol (IP) interface;
coupling one or more galvanically isolated digital inputs/outputs the APL IP interface;
coupling one or more external digital circuits to the APL IP interface; and
monitoring and controlling the one or more external digital circuits through IP via the APL IP interface.

12. The method of claim 11, further comprising connecting the APL IP interface to an industrial network via a plurality of redundant physical Ethernet-APL 10BaseT1L ports and enabling network traffic separation and high availability with the redundant ports.

13. The method of claim 12, wherein enabling network traffic separation is based on different classifications of traffic from the industrial network to the one or more external digital circuits.

14. The method of claim 11, further comprising connecting the APL IP interface to an industrial network via at least one Ethernet-APL switch and supplying Power over Data Lines (PoDL) to the APL IP interface via the at least one Ethernet-APL switch.

15. The method of claim 14, wherein connecting the APL IP interface to the industrial network via the at least one Ethernet-APL switch comprises connecting the APL IP interface connects to the at least one Ethernet-APL switch via two-wire intrinsically safe Ethernet (2-WISE) 10BaseT1L.

16. The method of claim 11, further comprising:
providing one or more analog interfaces on a 10BaseT1L Advanced Physical Layer (APL) Internet Protocol (IP) interface for at least one of a current-driven and a voltage-driven measurement device; and
providing power to the APL IP interface and the measurement device via an intrinsically safe (IS) APL connection.

17. The method of claim 16, further comprising enabling gateway functionality between one or more field device protocols and one or more industrial network protocols via the APL IP interface.

18. The method of claim 17, wherein the field device protocols include one or more of HART and Modbus RTU.

19. The method of claim 17, wherein enabling gateway functionality comprises operating the APL IP interface as an OPC-UA/FX server with publish/subscribe support for OPC-UA/FX clients.

20. The method of claim 11, further comprising connecting one or more edge devices to the APL IP interface.
